(19) United States
(12) Patent Application Publication
(10) Pub. No.: US 2012/0189188 A1
(43) Pub. Date: Jul. 26, 2012

(54) COMPONENT MOUNTING SYSTEM AND MOUNTING STATE INSPECTION METHOD IN THE COMPONENT MOUNTING SYSTEM

(75) Inventor: Daisuke Nagai, Yamanashi (JP)

(73) Assignee: PANASONIC CORPORATION, Osaka (JP)

(21) Appl. No.: 13/255,967

(22) PCT Filed: Sep. 28, 2010
(86) PCT No.: PCT/JP10/05837

§ 371 Date: Sep. 12, 2011

(30) Foreign Application Priority Data
Oct. 5, 2009 (JP) 2009-231273

(51) Int. Cl. G06K 9/00

(52) U.S. Cl. 382/145

(57) ABSTRACT

Provided is a component mounting system and a mounting state inspection method in the component mounting system in which accurate mounting state inspection can be achieved with good operability. A board image capturing operation for image-capturing an inspection range of a board to be inspected to acquire captured image data is executed on the board before and after mounting work is executed on the board by inspection modules M3A and M6A. A difference between pre-mounting image data and post-mounting image data thus acquired is calculated so that each component is extracted by a component extraction processing portion 3a. The shape and position of the extracted component are compared with inspection data indicating the shape and position of a normal component stored in advance so that whether the mounting state of each component on the board is good or not, is determined by a discrimination processing portion 3b. Consequently, unstable elements in a system for recognizing and extracting each component based on color information of the component and the board can be eliminated to achieve accurate mounting state inspection with good operability.

### TECHNICAL FIELD

The present invention relates to a component mounting system for mounting components on a board, and a mounting state inspection method in a component mounting system for inspecting a mounting state of each of components in the component mounting system.

### BACKGROUND ART

A component mounting system for mounting each component on a board to produce a mounted board is composed of a plurality of devices such as a solder printing device, a component mounting device, a reflow device, etc. which are connected so that each component is mounted on a board after solder printing. Before the mounted board is conveyed into the reflow device, the mounted board is inspected for confirming whether the mounting state is good or not. In the inspection of the mounting state, whether the kind of the mounted component is correct or not, whether each component is present in its mounting position or not, the positional displacement of each component, etc. are a subject of confirmation.

As an inspection device for inspecting the mounting state, there has been heretofore used a device which is formed so that the aforementioned items are checked based on an image obtained by image-capturing the board after component mounting (e.g. see Patent Document 1). In the Patent Document example, each component is recognized based on color information of the component and the board and extracted from an image acquired by scanning the board after component mounting, and an image of the extracted component is compared with component information stored in advance to thereby determine the mounting state of the component on the board.

### PRIOR TECHNICAL DOCUMENT

### Patent Document

Patent Document 1: JP-A-2009-21523

### SUMMARY OF THE INVENTION

### Problem that the Invention is to Solve

In the aforementioned prior technical example, the following disadvantage is however caused by the fact that each component is recognized based on color information of the component and the board when the component is extracted from the image obtained by image-capturing the board. That is, to extract each component correctly from an image of the board obtained by image-capturing, it is necessary to warrant reproducibility of color information for distinguishing the component from a top surface of the board. Boards or components are not necessarily produced in the same color even though the boards or components have the same part number. In most cases, the color varies according to each production lot, so that accuracy in extraction of each component based on color information is lowered.

If a portion unclear in terms of recognition processing, such as a solder-plated electrode, a silk-printed portion, etc. is disposed in a range of the board as the background of the component in the image so as to be close to the component, there arises the case where the component cannot be distinguished correctly from the board on the image. Moreover, because the acquired image depends on the state of illumination during image capturing, correct image information cannot be acquired to bring lowering of recognition accuracy if the state of illumination varies.

To eliminate the influence caused by variation in color of the component or board and variation in the state of illumination, it is necessary to perform a troublesome correcting process such as teaching of color information, calibration of the illumination state, etc. This causes lowering of handling property of an inspection operation. As described above, in the background art of the system of recognizing each component based on color information of the component and the board and extracting the component, there are lots of unstable elements in terms of keeping component extraction accuracy. There is a problem that it is difficult to achieve accurate mounting state inspection with good operability.

Therefore, an object of the invention is to provide a component mounting system and a mounting state inspection method in the component mounting system in which accurate mounting state inspection can be achieved with good operability.

### Means for Solving the Problem

The component mounting system according to the invention is a component mounting system with a mounting state inspection function for mounting components on a board and inspecting a mounting state of each of the mounted components, including: an un-mounted board image capturing portion which executes a board image capturing operation on the board before execution of component mounting work for image-capturing an inspection range of the board to be inspected to acquire captured image data; a component mounting portion which executes mounting work on the board after an image of the board has been captured by the un-mounted board image capturing portion; a mounted board image capturing portion which executes the board image capturing operation on the board after execution of the mounting work; a component extraction processing portion which calculates a difference between pre-mounting image data acquired by the un-mounted board image capturing portion and post-mounting image data acquired by the mounted board image capturing portion to thereby extract each component mounted by the mounting work; and a discrimination processing portion which compares the shape and position of the component extracted by the component extraction processing portion with inspection data indicating the shape and position of a normal component stored in advance to thereby determine whether the mounting state of each component on the board is good or not.

The mounting state inspection method in the component mounting system according to the invention is a mounting state inspection method for inspecting a mounting state of each component mounted in a component mounting system for mounting components on a board, including: an un-mounted board image capturing step of executing a board image capturing operation on the board before execution of component mounting work for image-capturing an inspection range of the board to be inspected to acquire captured image data; a component mounting step of executing mounting work on the board after the un-mounted board image capturing step; a mounted board image capturing step of executing the board image capturing operation on the board after the mounting work has been executed on the board; a component extraction processing step of calculating a difference between pre-mounting image data acquired by the un-mounted board image capturing portion and post-mounting image data acquired by the mounted board image capturing portion to thereby extract each component mounted in the component mounting step; and a discrimination processing step of comparing the shape and position of the component extracted in the component extraction processing step with inspection data indicating the shape and position of a normal component stored in advance to thereby determine whether the mounting state of each component on the board is good or not.

### Effect of the Invention

According to the invention, there is used the following method. That is, a board image capturing operation for image-capturing an inspection range of a board to be inspected to acquire captured image data is executed on the board before and after mounting work is executed on the board. A difference between pre-mounting image data and post-mounting image data thus acquired is calculated to thereby extract each component. The shape and position of the extracted component are compared with inspection data indicating the shape and position of a normal component stored in advance to thereby determine whether the mounting state of each component on the board is good or not. By using the method, unstable elements in a system for recognizing and extracting each component based on color information of the component and the board can be eliminated to achieve accurate mounting state inspection with good operability.

### BRIEF DESCRIPTION OF DRAWINGS

FIG. 1 is a view for explaining the configuration of a component mounting system according to an embodiment of the invention.

FIGS. 2 (a) and (b) are views for explaining the configuration of an inspection/mounting module in the component mounting system according to an embodiment of the invention.

FIG. 3 is a block diagram showing the configuration of a component mounting state inspection function in the component mounting system according to an embodiment of the invention.

FIGS. 4 (a), (b) and (c) are views for explaining steps in a mounting state inspection method in the component mounting system according to an embodiment of the invention.

FIGS. 5 (a), (b) and (c) are views for explaining steps in a mounting state inspection method in the component mounting system according to an embodiment of the invention.

FIGS. 6 (a), (b) and (c) are views for explaining steps in a mounting state inspection method in the component mounting system according to an embodiment of the invention.

### MODE FOR CARRYING OUT THE INVENTION

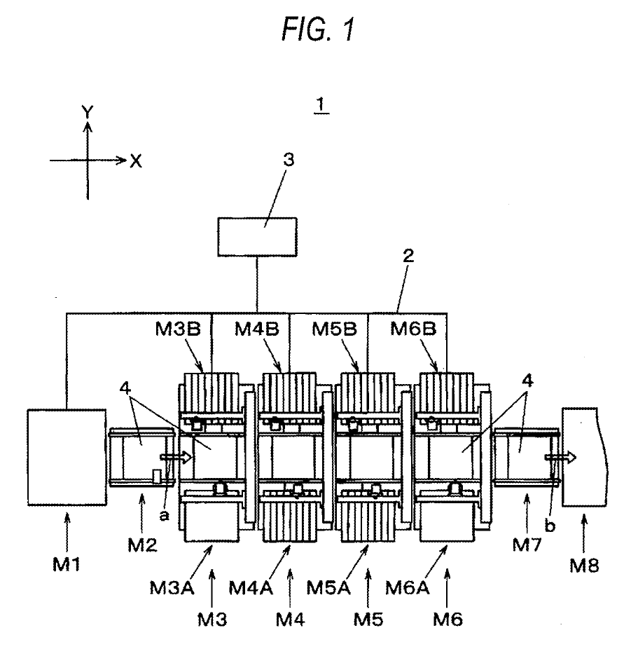

A mode for carrying out the invention will be described below with reference to the drawings. Referring first to FIG. 1, a component mounting system 1 for mounting electronic components on a board to produce a mounted board will be described. In FIG. 1, the component mounting system 1 has, as a main body, a component mounting line having respective modules, i.e. a printing module M1, a board delivery module M2, an inspection/mounting module M3, component mounting modules M4 and M5, an inspection/mounting module M6, a board delivery module M7, and a reflow module M8 which are connected in a board conveyance direction (X direction). The respective modules which form the component mounting line are connected to one another by a communication network 2 and controlled by a host device 3 having a function of a management computer.

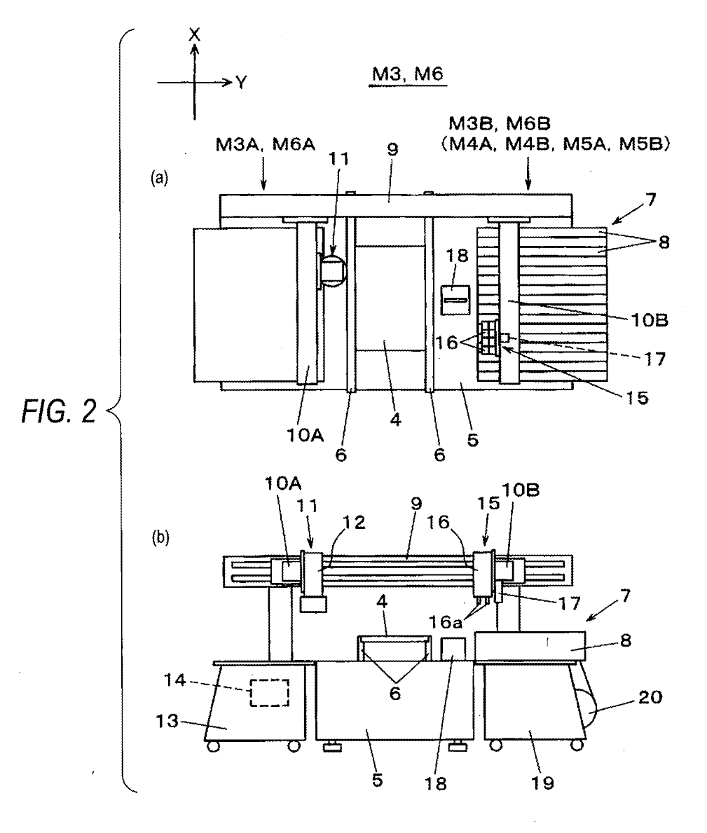

The printing module M1 performs screen printing of component joint solder paste on component connection lands of a board 4. The board delivery module M2 delivers the printed board 4 received from the printing module M1 to a downstream side module at a predetermined timing (arrow a). Each of the inspection/mounting module M3, the component mounting modules M4 and M5 and the inspection/mounting module M6 is formed so that a work operating mechanism such as an inspection mechanism, a component mounting mechanism, etc. is disposed on each of both sides of a board conveyance portion 6 (see FIGS. 2(a) and 2(b)) which conveys the board 4 in a board conveyance direction.

The inspection/mounting module M3 has an inspection module M3A and a component mounting module M3B as work operating mechanisms. The inspection module M3A inspects a solder printing state by image-capturing the printed board 4 and performs a board image capturing operation for acquiring captured image data by image-capturing an inspection range of the board 4 to be inspected for the purpose of inspecting the mounting state. That is, the inspection module M3A serves as an un-mounted board image capturing portion which executes a board image capturing operation on the board 4 before execution of component mounting work.

The component mounting module M3B mounts a component on the board 4 after solder printing inspection. Each of the component mounting modules M4 and M5 has two component mounting modules M4A and M4B (or M5A and M5B) which can perform work operations independently. Components are mounted on the board 4 successively by these component mounting modules. The inspection/mounting module M6 has an inspection module M6A and a component mounting module M6B. The component mounting module M6B mounts a component on the board 4. The inspection module M6A image-captures the board 4 after component mounting work on the board 4 has been completed by the respective component mounting modules on the upstream side.

In this embodiment, the component mounting modules M3B, M4A, M4B, M5A, M5B and M6B serve as component mounting portions which execute mounting work on the board 4 after an image of the board 4 has been captured by the inspection module M3A serving as an un-mounted board image capturing portion. The inspection module M6A serves as a mounted board image capturing portion which executes a board image capturing operation on the board 4 on which mounting work has been executed by the component mounting portions, in order to image-capture an inspection range of the board 4 to be inspected to acquire captured image data. The inspected board 4 is conveyed into the reflow module M8 through the board delivery module M7 (arrow b). In the reflow module M8, the inspected board 4 is heated to melt and solidify solder so that components are soldered to the board 4.

The structure of the inspection/mounting module M3 or M6 will be described next with reference to FIGS. 2(a) and 2(b). Incidentally, the component mounting module M4A, M4B, M5A or M5B of the component mounting module M4 or M5 has the same configuration as that of the component mounting module M3B or M6B shown in FIG. 2(a) or 2(b) and description thereof will be therefore omitted. In FIG. 2(a) or 2(b), a board conveyance portion 6 having two conveyance rails is disposed in the X direction in the center portion of a base 5. The board conveyance portion 6 conveys the board 4 received from the upstream side module to the downstream side and aligns and holds the board 4 in a work position in the module. A predetermined work operation is executed on the board 4 aligned and held in each board conveyance portion 6 by corresponding one of the inspection module M3A and the component mounting module M3B or corresponding one of the inspection module M6A and the component mounting module M6B.

A component supply portion 7 is disposed in each of the component mounting modules M3B and M6B. A wagon 19 on which tape feeders 8 are mounted in parallel is disposed in the component supply portion 7. Each tape feeder 8 pulls out a carrier tape with a component held thereon from a tape supply reel 20 set in the wagon 19 and pitch-feeds the carrier tape to thereby supply the component to a pickup position to be performed by a component loading portion which will be described later.

A Y-axis moving table 9 having a linearly moving mechanism performed by a linear motor is disposed in a Y direction in one X-direction end portion of the base 5. X-axis moving tables 10A and 10B each having a linearly moving mechanism performed by a linear motor likewise extends in the X direction and are attached to the Y-axis moving table 9 so as to be movable in the Y direction. The X-axis moving tables 10A and 10B correspond to the inspection module M3A and the component mounting module M3B respectively or correspond to the inspection module M6A and the component mounting module M6B respectively.

A loading head 15 having a plurality of unit loading heads 16 is attached to the X-axis moving table 10B so that the loading head 15 can move in the X direction. A board image capturing portion 17 moving together with the loading head 15 is disposed on a lower surface side of the X-axis moving table 10B. An image capturing head 11 having an image capturing camera 12 is attached to the X-axis moving table 10A so as to be movable in the X direction. A wagon 13 having a built-in image recognition unit 14 is attached to each of the inspection modules M3A and M6A.

Operation of each of the component mounting modules M3B and M6B will be described. By driving the Y-axis moving table 9 and the X-axis moving table 10B, the loading head 15 is moved horizontally in the X direction and in the Y direction so that a component is taken out from the tape feeders 8 of the component supply portion 7 by suction nozzles 16a attached to lower end portions of the unit loading heads 16 and is mounted on the board 4 aligned and held by the board conveyance portion 6. The Y-axis moving table 9, the X-axis moving table 10B and the loading head 15 form a component loading portion in which a component is taken out from the component supply portion 7 by the loading head 15 and moved and loaded onto a mounting position of the board 4 aligned and held by the board conveyance portion 6. By moving the board image capturing portion 17 together with the loading head 15, the board image capturing portion 17 is moved above the board 4 and image-captures the board 4. An image acquired by image capturing is subjected to recognition processing so that a recognition mark or a component mounting position provided on the board 4 can be recognized.

A component image capturing portion 18 is disposed in a moving path of the loading head 15 between the component supply portion 7 and the board conveyance portion 6. The loading head 15 having a component held by the suction nozzles 16a is moved above the component image capturing portion 18 in the X direction so that the component held by the loading head 15 is image-captured by the component image capturing portion 18. An image acquired by image capturing is subjected to recognition processing to thereby acquire position information indicating the positional displacement of the component from a normal position. In an operation of loading a component on the board 4, position correction of the loading position is performed based on the positional information.

Operation of each of the inspection modules M3A and M6A will be described. By driving the Y-axis moving table 9 and the X-axis moving table 10A, the image capturing head 11 is moved horizontally in the X direction and in the Y direction. Consequently, each of the inspection modules M3A and M6A acquires captured image data in such a manner that the image capturing camera 12 mage-captures an inspection range (to be inspected) of the board 4 aligned and held by the board conveyance portion 6 before and after component mounting.

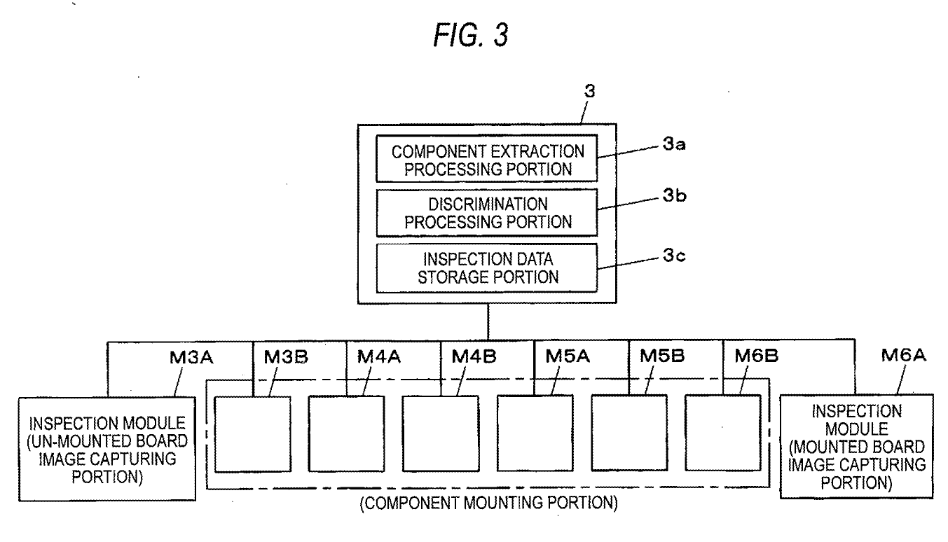

A component mounting state inspection function in the component mounting system 1 will be described next with reference to FIG. 3. The host device 3 generally controls the inspection module M3A serving as an un-mounted board image capturing portion, the component mounting modules M3B, M4A, M4B, M5A, M5B and M6B forming component mounting portions, and the inspection module M6A serving as a mounted board image capturing portion. The host device 3 has a component extraction processing portion 3a, a discrimination processing portion 3b and an inspection data storage portion 3c as internal processing functions concerned with component mounting state inspection.

The component extraction processing portion 3a calculates a difference between pre-mounting image data acquired by the inspection module M3A and post-mounting image data acquired by the inspection module M6A to thereby perform a process of extracting a component mounted by the mounting work. The discrimination processing portion 3b compares the shape and position of the component extracted by the component extraction processing portion 3a with inspection data indicating the shape and position of a normal component stored in advance to thereby determine whether the mounting state of the component on the board 4 is good or not. The inspection data storage portion 3c stores the inspection data used when the discrimination processing portion 3b determines whether the mounting state is good or not.

In the aforementioned configuration, the inspection module M3A serving as an un-mounted board image capturing portion, the component mounting modules M3B, M4A, M4B, M5A, M5B and M6B serving as component mounting portions, the inspection module M6A serving as a mounted board image capturing portion and the component extraction processing portion 3a, the discrimination processing portion 3b and the inspection data storage portion 3c as the internal processing functions of the host device 3 correspond to a component mounting system having a mounting state inspection function for mounting components on the board 4 and inspecting the mounting state of each mounted component.

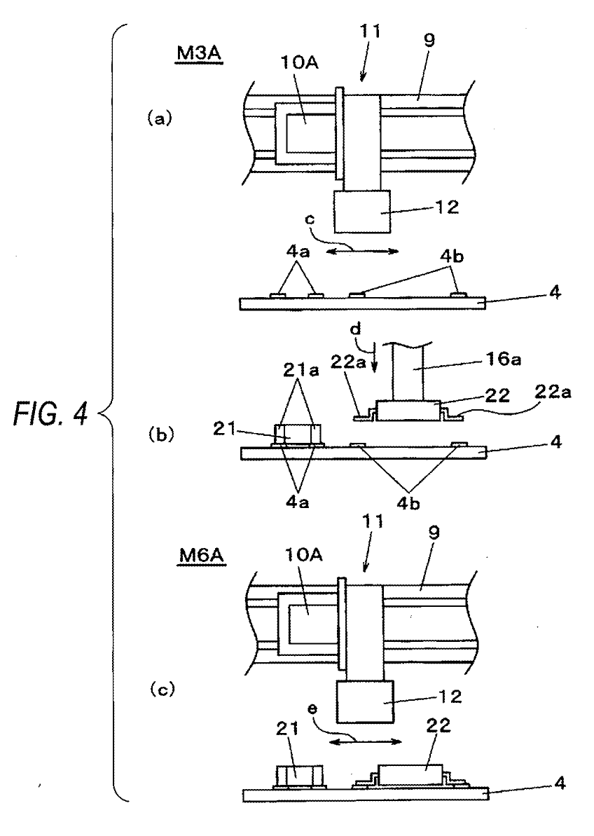

In the component mounting system having the mounting state inspection function configured as described above, a mounting state inspection method for inspecting the mounting state of each mounted component will be described next with reference to FIGS. 4(a) to 4(c), FIGS. 5(a) to 5(c) and FIGS. 6(a) to 6(c). After the board 4 is subjected to solder printing by the printing module M1, the board 4 is first conveyed into the inspection/mounting module M3 where a board image capturing operation is executed on the board 4 by the inspection module M3A before execution of component mounting work on the board 4 (un-mounted board image capturing step). That is, as shown in FIG. 4(a), the Y-axis moving table 9 and the X-axis moving table 10A are driven to move the image capturing head 11 successively above the board 4 (arrow c), so that a range of the board 4 to be inspected is image-captured by the image capturing camera 12 to acquire captured image data.

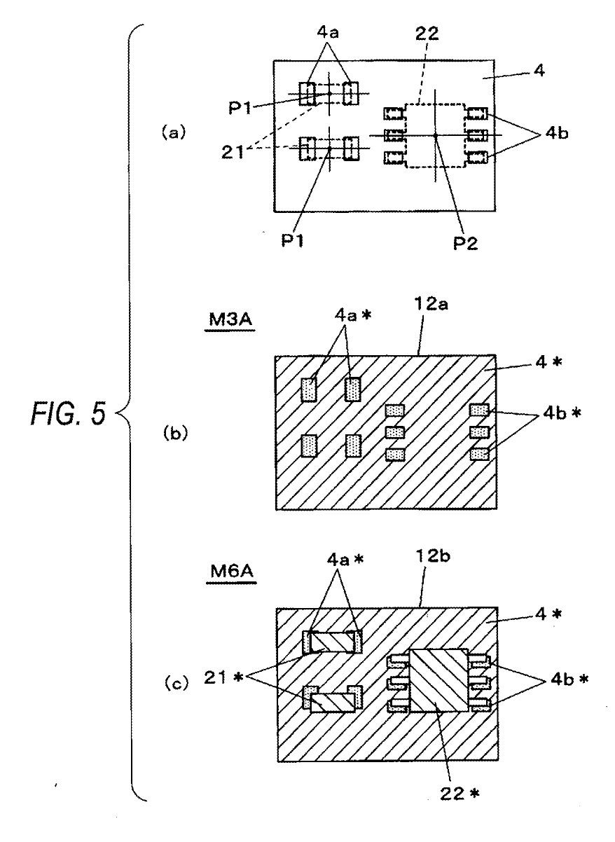

The range of the board 4 to be inspected will be described here with reference to FIG. 5(a). In FIG. 5(a), two mount points P1 where two terminal type components 21 will be mounted respectively and a mount point P2 where a lead-including component 22 will be mounted are set on a mount surface of the board 4. Lands 4a are formed in positions symmetrical with respect to the mount points P1 so as to correspond to positions of terminals 21a (see FIG. 4(b)) of the components 21. Lands 4b are formed around the mount point P2 so as to correspond to positions of leads 22a (see FIG. 4(b)) of the component 22. The range of the board 4 to be inspected is set so as to include a land forming range of the lands 4a, 4b, etc. corresponding to the components to be mounted.

By image-capturing the range of the board 4 to be inspected, a pre-mounting image 12a shown in FIG. 5(b) is acquired by the inspection module M3A serving as an un-mounted board image capturing portion. In the pre-mounting image 12a, land images 4a* and 4b* corresponding to the lands 4a and 4b appear in a background portion 4* corresponding to a surface of the board 4. Pre-mounting image data forming the pre-mounting image 12a are sent to the host device 3 through the communication network 2.

Then, mounting work is executed on the board 4 after the un-mounted board image capturing step (component mounting step). In the step, the board 4 is loaded with the components 21 and 22 aiming at the mount points P1 and P2 respectively by any one of the component mounting modules M3B, M4A, M4B, M5A, M5B and M6B. That is, as shown in FIG. 4(b), while the components 21 are held by the suction nozzles 16a, the terminals 21a are placed on the lands 4a, and then the component 22 held by the suction nozzles 16a is moved down while the leads 22a are aligned with the lands 4b respectively (arrow d). Although the case where two kinds of components 21 and 22 are mounted is shown here to simplify description, a large number of components are actually mounted successively by a plurality of component mounting modules.

After execution of the mounting work on the board 4, a board image capturing operation is then executed on the board 4 by the inspection module M6A serving as a mounted board image capturing portion (mounted board image capturing step). That is, as shown in FIG. 4(c), the Y-axis moving table 9 and the X-axis moving table 10A are driven to move the image capturing head 11 successively above the board 4 (arrow e), so that the range of the board 4 to be inspected is image-captured by the image capturing camera 12 to thereby acquire captured image data. Consequently, as shown in FIG. 5(c), a post-mounting image 12b is acquired. In the post-mounting image 12b, component regions 21* and 22* corresponding to the mounted components 21 and 22 as well as the land images 4a* and 4b* corresponding to the lands 4a and 4b appear in the background portion 4* corresponding to the surface of the board 4. Post-mounting image data forming the post-mounting image 12b are sent to the host device 3 through the communication network 2.

Then, a difference between the pre-mounting image data acquired by the inspection module M3A and the post-mounting image data acquired by the inspection module M6A is calculated to thereby extract the components 21 and 22 mounted in the component mounting step (component extraction processing step). That is, an image computing process is performed for subtracting image data of respective pixels forming the pre-mounting image 12a from image data of respective pixels forming the post-mounting image 12b in accordance with each corresponding pixel.

Consequently, image data cancel each other in a region where image data are common to the pre-mounting image 12a and the post-mounting image 12b, that is, in the background portion 4* and the land images 4a* and 4b*. On the contrary, in the component regions 21* and 22* corresponding to the components 21 and 22 in the post-mounting image 12b, image data corresponding to the background portion 4* is subtracted from image data corresponding to the component regions 21* and 22* respectively, so that image data do not cancel each other in the regions of the components 21 and 22.

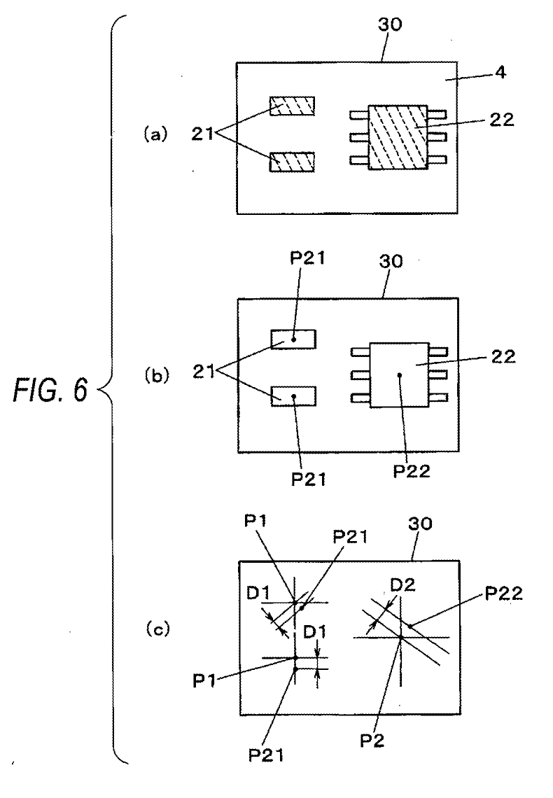

By performing such an image computing process, a recognition image 30 shown in FIG. 6(a) is acquired. In the recognition image 30, the components 21 and 22 are expressed in the background image corresponding to the surface of the board 4 so that the components 21 and 22 can be distinguished from the background image. Consequently, the components 21 and 22 are extracted in the recognition image 30. Then, as shown in FIG. 6(b), an arithmetic operation is performed for calculating the shapes and positions of the components 21 and 22. Consequently, the shapes, sizes and positions of the components 21 and 22 are detected so that component detection positions P21 and P22 indicating the centers of the components are calculated.

Then, the shapes and positions of the components extracted in the component extraction processing step are compared with inspection data indicating the shapes, sizes and positions of normal components stored in the inspection data storage portion 3c in advance so that determination is made by the discrimination processing portion 3b as to whether the mounting state of each component on the board 4 is good or not (discrimination processing step).

That is, as shown in FIG. 6(c), a positional displacement amount D1 indicating the degree of positional difference between each component detection position P21 and a corresponding mount point P1 and a positional displacement amount D2 indicating the degree of positional difference between the component detection position P22 and the mount point P2 are calculated respectively and these positional displacement amounts D1 and D2 are compared with positional displacement permissible values (inspection data) stored in the inspection data storage portion 3c to thereby determine whether the mounting state of each of the components 21 and 22 on the board 4 is good or not.

As described above, in the mounting state inspection method in the component mounting system according to this embodiment, components are extracted by calculating a difference between pre-mounting image data and post-mounting image data acquired by execution of a board image capturing operation on the board 4 before and after execution of mounting work, for acquiring image data by image-capturing an inspection range of the board 4 to be inspected. Accordingly, unstable elements in the system according to the background art in which components are recognized and extracted based on color information of the components and the board can be eliminated to achieve accurate mounting state inspection with good operability.

Although the embodiment has been described on an example of configuration of equipment in which component mounting modules M4 and M5 are disposed between two inspection/mounting modules M3 and M6 as shown in FIG. 1, the configuration of the component mounting system according to the invention is not limited to the configuration example shown in FIG. 1 but the invention can be applied to any equipment configuration as long as it can execute the un-mounted board image capturing step, the component mounting step and the mounted board image capturing step successively as a sequence of steps. For example, the two inspection/mounting modules M3 and M6 may be replaced by inspection modules each having only one inspection function. In addition, one inspection/mounting module may be used for executing the un-mounted board image capturing step, the component mounting step and the mounted board image capturing step.

This application is based on Japanese Patent Application (Patent Application 2009-231273) filed on Oct. 5, 2009 and the contents of which should be incorporated herein by reference.

### INDUSTRIAL APPLICABILITY

The component mounting system and the mounting state inspection method in the component mounting system according to the invention have an effect in that accurate mounting state inspection can be achieved with good operability, and they are useful in the component mounting field for mounting components on a board to produce a mounted board.

### DESCRIPTION OF THE REFERENCE CHARACTERS AND SIGNS

1 component mounting system
3 host device
4 board
6 board conveyance portion
7 component supply portion
9 Y-axis moving table
10A, 10B X-axis moving table
11 image capturing head
12 image capturing camera
12a pre-mounting image
12b post-mounting image
15 loading head
21 component
22 component
P1, P2 mount point
P21, P22 component detection position

1. A component mounting system with a mounting state inspection function for mounting components on a board and inspecting a mounting state of each of the mounted components, comprising:
an un-mounted board image capturing portion which executes a board image capturing operation on the board before execution of component mounting work for image-capturing an inspection range of the board to be inspected to acquire captured image data;
a component mounting portion which executes mounting work on the board after an image of the board has been captured by the un-mounted board image capturing portion;
a mounted board image capturing portion which executes the board image capturing operation on the board after the mounting work has been executed on the board;
a component extraction processing portion which calculates a difference between pre-mounting image data acquired by the un-mounted board image capturing portion and post-mounting image data acquired by the mounted board image capturing portion to thereby extract each component mounted by the mounting work; and
a discrimination processing portion which compares the shape and position of the component extracted by the component extraction processing portion with inspection data indicating the shape and position of a normal component stored in advance to thereby determine whether the mounting state of each component on the board is good or not.

2. A mounting state inspection method for inspecting a mounting state of each component mounted in a component mounting system for mounting components on a board, comprising:
an un-mounted board image capturing step of executing a board image capturing operation on the board before execution of component mounting work for image-capturing an inspection range of the board to be inspected to acquire captured image data;
a component mounting step of executing mounting work on the board after the un-mounted board image capturing step;
a mounted board image capturing step of executing the board image capturing operation on the board after the mounting work has been executed on the board;
a component extraction processing step of calculating a difference between pre-mounting image data acquired by the un-mounted board image capturing portion and post-mounting image data acquired by the mounted board image capturing portion to thereby extract each component mounted in the component mounting step; and
a discrimination processing step of comparing the shape and position of the component extracted in the component extraction processing step with inspection data indicating the shape and position of a normal component stored in advance to thereby determine whether the mounting state of each component on the board is good or not.
